(19) United States
(12) Patent Application Publication
(10) Pub. No.: US 2026/0275669 A1
(43) Pub. Date: Sep. 17, 2026

(54) TRASH INTERCEPTING AND SEDIMENT BARRIER DEVICE

(71) Applicant: CHINA THREE GORGES UNIVERSITY, Yichang City (CN)

(72) Inventors: Changwen LI, Yichang City (CN); Zirui YANG, Yichang City (CN); Yuhao PAN, Yichang City (CN); Haoxiong ZHAN, Yichang City (CN); Chenxue GONG, Yichang City (CN); Mingshan JIANG, Yichang City (CN); Yujia HUANG, Yichang City (CN)

(21) Appl. No.: 19/423,010

(22) Filed: Dec. 17, 2025

(30) Foreign Application Priority Data
Mar. 11, 2025 (CN) 202510280161.9

(51) Int. Cl. E02B 15/10; B01D 29/05; B01D 29/60; B01D 35/05; C02F 1/00; E02B 5/08; C02F 103/00

(52) U.S. Cl. CPC E02B 15/10; B01D 29/05; B01D 29/603; B01D 35/05; C02F 1/004; C02F 1/008; E02B 5/085; C02F 2103/007; C02F 2209/40

(57) ABSTRACT

Provided is a trash intercepting and sediment barrier device. The trash intercepting and sediment barrier device includes a frame, a sediment collecting device, an intercepting device and a hoisting device. The intercepting device includes a float, an intercepting net and a sediment barrier plate. The float is fixed on the frame. An upper end of the intercepting net is connected to the float. A lower end of the intercepting net is connected with a counterweight. An upper end of the sediment barrier plate is connected to the lower end of the intercepting net. The sediment barrier plate includes a plurality of sediment barrier plate units that are sequentially hinged along a height direction. The sediment collecting device includes a collecting tank. The collecting tank is arranged at a downstream side of the intercepting device. A side of the collecting tank facing an incoming flow is provided with an inlet.

### CROSS REFERENCE TO RELATED APPLICATION

This patent application claims the benefit and priority of Chinese Patent Application No. 2025102801619, filed with the China National Intellectual Property Administration on March 11, 2025, the disclosure of which is incorporated by reference herein in its entirety as part of the present application.

### TECHNICAL FIELD

The present disclosure relates to the technical field of water conservancy and environmental protection equipment, and in particular to a trash intercepting and sediment barrier device.

### BACKGROUND

In numerous ditches and small rivers, the accumulation of trash and sediment is a widespread problem. The sources of trash are diverse, including household waste, agricultural production waste and floating debris washed down from the upstream. The trash not only makes the river aesthetically unpleasing, but also cause water pollution and damage the aquatic ecosystem. Deposition of sediment reduces the cross-section of the river, diminishing the flood discharge capacity of the river and increasing the risk of flooding. Moreover, deposition of sediment also adversely affects the habitat of aquatic organisms in the river.

Currently, there are limited methods to harness artificial ditches and small and medium-sized rivers, and there is a lack of devices capable of intercepting trash and blocking sediment. The conventional manual cleaning method is inefficient and costly, and cannot fundamentally solve the problem that trash and sediment continuously enter the river. Some simple trash intercepting facilities having a simple structure can only intercept large trash, but cannot deal with small trash and sediment. Moreover, these facilities are easily washed away by a large water flow, exhibiting poor stability. Conventional trash racks are prone to clogging, and it is inefficient to manually clean the trash racks. Some sediment barrier devices are prone to changing direction under the impact of the water flow or unable to effectively disperse the impact of the water flow, such that the sediment cannot be removed effectively. Therefore, there is an urgent need in the art for a trash intercepting and sediment barrier device, to solve the problem that the prior art cannot effectively harness artificial ditches and small and medium-sized rivers.

### SUMMARY

An objective of the present disclosure is to provide a trash intercepting and sediment barrier device to solve the problems in the prior art. The trash intercepting and sediment barrier device can be used for harnessing artificial ditches and small and medium-sized rivers to effectively intercept trash and sediment with high stability and lower labor cost.

To achieve the above objective, the present disclosure provides the following technical solutions.

The present disclosure provides a trash intercepting and sediment barrier device, including a frame, a sediment collecting device, an intercepting device and a hoisting device. The intercepting device includes a float, an intercepting net and a sediment barrier plate. The float is fixed on the frame. An upper end of the intercepting net is connected to the float. A lower end of the intercepting net is connected with a counterweight. An upper end of the sediment barrier plate is connected to the lower end of the intercepting net. The sediment barrier plate includes a plurality of sediment barrier plate units that are sequentially hinged along a height direction. The sediment collecting device includes a collecting tank. The collecting tank is arranged at a downstream side of the intercepting device. A side of the collecting tank facing an incoming flow is provided with an inlet. The collecting tank is connected to the hoisting device through slings. The hoisting device is fixedly mounted on the frame. An upper end of the frame is provided with a closing plate. The closing plate is mounted at the inlet of the collecting tank and configured to close the inlet.

In an implementation, the intercepting net includes a plurality of intercepting net layers that are arranged sequentially, and mesh sizes of the intercepting net layers gradually decrease along a water flow direction.

In an implementation, the upper end of the intercepting net is connected to the float through lifting rings.

In an implementation, an inner side of the frame is fixedly provided with an integrated sensor, and the integrated sensor integrates a water quality sensor, a flow sensor and a sediment content sensor.

In an implementation, a bottom of the collecting tank is an arc-shaped surface, and the arc-shaped surface faces the incoming flow.

In an implementation, the float includes floating balls and long floating cylinders that are connected alternately.

In an implementation, the hoisting device includes four winches, and the four winches are respectively connected to four corners of the collecting tank through the slings.

In an implementation, there are a plurality of the counterweights that are arranged at equal intervals along a length direction of the intercepting net.

In an implementation, outer side surfaces of side walls of an opening of the collecting tank are each provided with a vertical sliding rail, and inner sides of two ends of the closing plate are each provided with a sliding groove fitted with the vertical sliding rail.

Compared with the prior art, the present disclosure has the following technical effects:

According to the trash intercepting and sediment barrier device provided in the present disclosure, the intercepting net and the sediment barrier plate are connected below the float. Under the action of the counterweights, the intercepting net can effectively intercept solid household trash. The sediment barrier plate has a multi-section structure, and the sediment barrier plate units are hinged. Under the impact of the water flow, the sediment barrier plate can deform into an arc shape. When water carrying sediment flows through the sediment barrier plate, the arc-shaped surface redirects the water flow. Sediment particles collide with the sediment barrier plate and then gently flow along the arc into the bottom of the river, such that the sediment is separated from the water flow and then collected by the collecting tank. After the sediment in the collecting tank is collected to a certain extent, the collecting tank may be lifted by the hoisting device, and then the closing plate may be mounted to the inlet of the collecting tank to prevent the sediment from flowing out. Next, the collecting tank is loaded to a truck and transported to a designated place for disposal. The trash intercepting and sediment barrier device can be used for harnessing artificial ditches and small and medium-sized rivers to effectively intercept trash and sediment with high stability, thereby greatly reducing the workload and frequency of manual cleaning, lowering the maintenance cost and improving the working efficiency.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic structural view of a trash intercepting and sediment barrier device in an embodiment of the present disclosure;

FIG. 2 is a sectional view of the trash intercepting and sediment barrier device in an embodiment of the present disclosure;

FIG. 3 is a schematic structural view of a sediment barrier plate in an embodiment of the present disclosure;

FIG. 4 is a schematic view showing a float connected with an intercepting net in an embodiment of the present disclosure;

FIG. 5 is a front view of the trash intercepting and sediment barrier device along a water flow direction in an embodiment of the present disclosure;

FIG. 6 is a schematic partial structural view of an end of a closing plate in an embodiment of the present disclosure; and

FIG. 7 is a schematic partial structural view of a side wall of a collecting tank in an embodiment of the present disclosure.

In the figures: 1-frame, 2-float, 3-intercepting net, 4-sediment barrier plate, 5-counterweight, 6-sediment barrier plate unit, 7-collecting tank, 8-sling, 9-closing plate, 10-lifting ring, 11-integrated sensor, 12-arc-shaped surface, 13-floating ball, 14-long floating cylinder, 15-winch, 16-vertical sliding rail, 17-sliding groove.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a trash intercepting and sediment barrier device to solve the problems in the prior art. The trash intercepting and sediment barrier device can be used for harnessing artificial ditches and small and medium-sized rivers to effectively intercept trash and sediment with high stability and lower labor cost.

In order to make the above objective, features and advantages of the present disclosure clearer and more comprehensible, the present disclosure will be further described in detail below in combination with accompanying drawings and particular implementation modes.

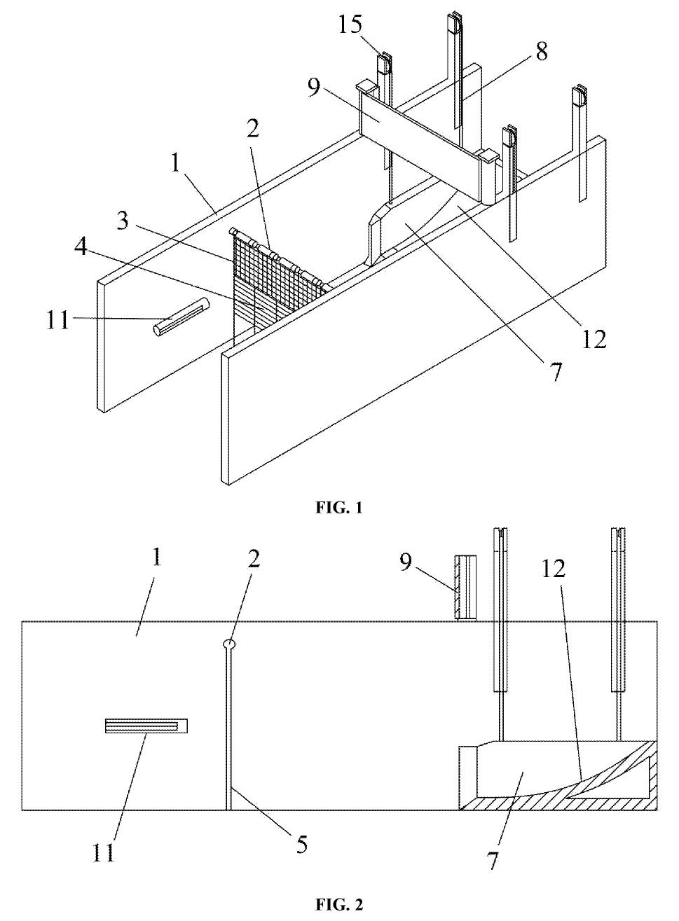

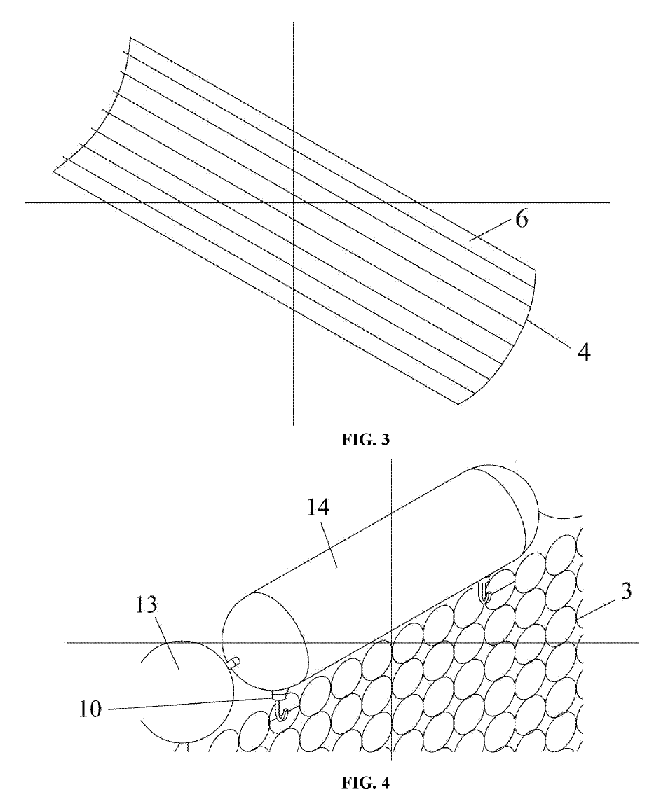

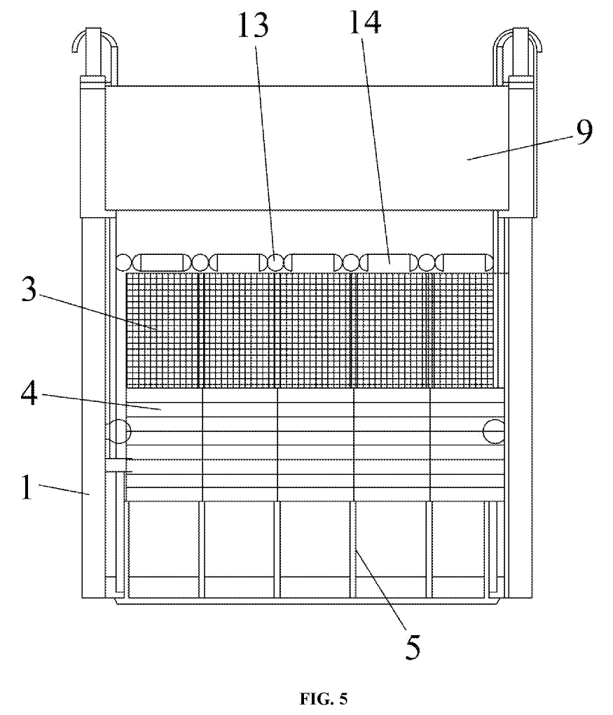

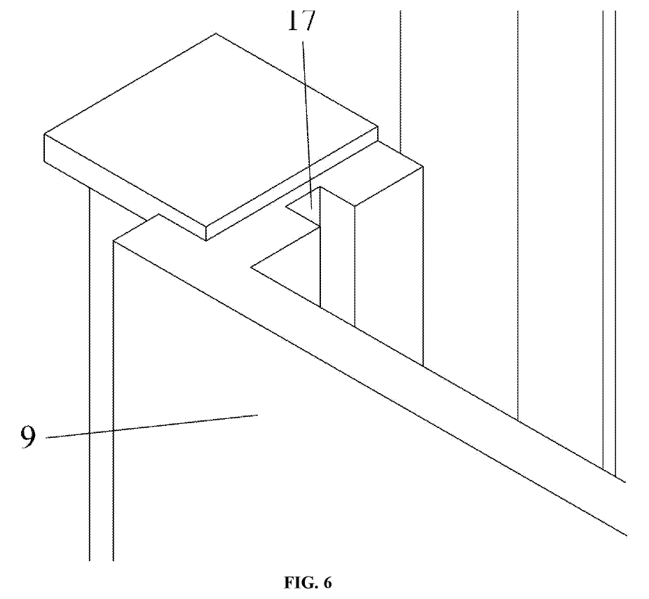

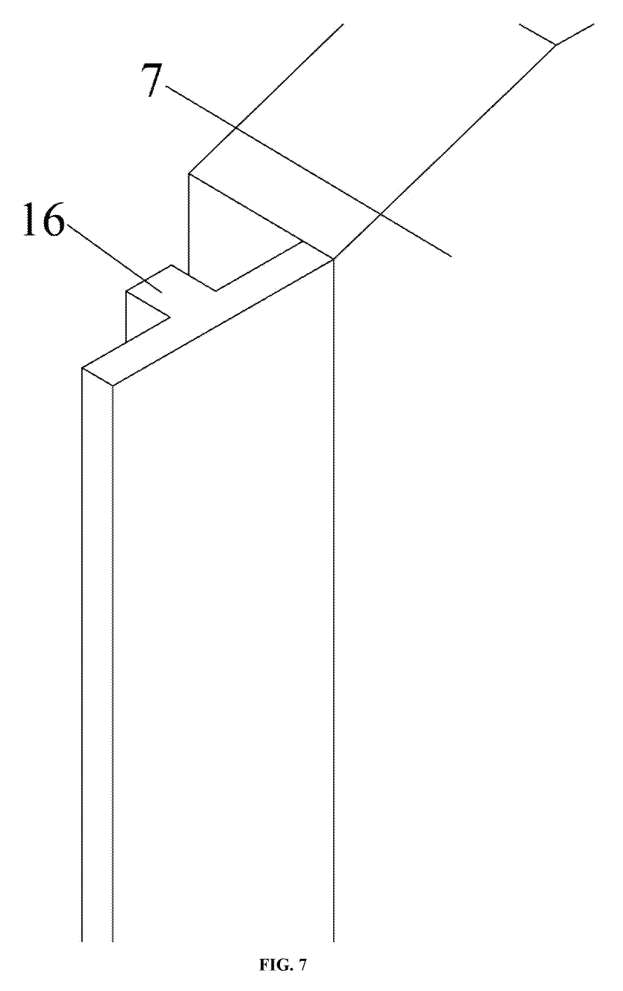

As shown in FIGS. 1 to 7, this embodiment provides a trash intercepting and sediment barrier device, including a frame 1, a sediment collecting device, an intercepting device and a hoisting device. The intercepting device includes a float 2, an intercepting net 3 and a sediment barrier plate 4. The float 2 is fixed on the frame 1. An upper end of the intercepting net 3 is connected to the float 2. A lower end of the intercepting net 3 is connected with a counterweight 5. An upper end of the sediment barrier plate 4 is connected to the lower end of the intercepting net 3. The sediment barrier plate 4 includes a plurality of sediment barrier plate units 6 that are sequentially hinged along a height direction. The sediment collecting device includes a collecting tank 7. The collecting tank 7 is arranged at a downstream side of the intercepting device. A side of the collecting tank 7 facing an incoming flow is provided with an inlet. The collecting tank 7 is connected to the hoisting device through slings 8. The hoisting device is fixedly mounted on the frame 1. An upper end of the frame 1 is provided with a closing plate 9. The closing plate 9 is mounted at the inlet of the collecting tank 7 and configured to close the inlet.

The frame 1 provides a mounting and supporting carrier for other components in the device. When the water level rises or falls, the float 2 has enough buoyancy, so that the trash intercepting device can rise and fall with the water level. In this way, the intercepting net 3 can always stay near the water level to block debris, and the sediment barrier plate 4 can always move with the intercepting net 3 to block sediment.

The sediment barrier plate units 6 may be hinged through hinges. Under the impact of the water flow, the sediment barrier plate 4 may deform into an arc shape. The sediment barrier plate 4 and the riverbed form a structure with a gradually decreasing space, such that the water flow is squeezed. The flow velocity of the lower layer is higher than that of the upper layer, such that the suspended load is brought to the lower layer to become the bed load and finally enters the collecting tank 7. Because the sediment barrier plate 4 is arc-shaped, the fluid can smoothly flow into the collecting tank 7 without directly impacting the riverbed, thereby avoiding the increase of more sediment caused by the impact of the bed sand.

The frame 1 is made of a corrosion-resistant material, such as high-strength water-resistant alloys or corrosion-resistant engineering plastics, which can effectively resist corrosion of river water and prolong the service life of the device.

In this embodiment, the intercepting net 3 includes a plurality of intercepting net layers that are arranged sequentially, and mesh sizes of the intercepting net layers gradually decrease along a water flow direction. The intercepting net can effectively intercept different sizes of solid household trash, including large floating objects and small debris.

In this embodiment, the upper end of the intercepting net 3 is connected to the float 2 through lifting rings 10. To replace the intercepting net 3, the intercepting net 3 can be directly removed from the lifting rings 10. With the lifting rings, the intercepting net 3 can be mounted and removed conveniently.

In this embodiment, an inner side of the frame 1 is fixedly provided with an integrated sensor 11, and the integrated sensor 11 integrates a water quality sensor, a flow sensor and a sediment content sensor. The water quality sensor monitors the fluctuation of water quality in real time. The flow sensor monitors a water velocity. The sediment content sensor monitors a sediment concentration. The sensors monitor the parameters of water quality in real time, and feed the parameters to a terminal platform through a wireless transmission module, thereby providing an accurate data support for river management. When any parameter exceeds a set threshold, a reminder alarm will be given, so that people can take countermeasures in time.

In this embodiment, a bottom of the collecting tank 7 is an arc-shaped surface 12, and the arc-shaped surface 12 faces the incoming flow, so that the incoming flow carrying sediment can be buffered, thereby reducing the influence on the original morphology of the river.

In this embodiment, the float 2 includes floating balls 13 and long floating cylinders 14 that are connected alternately. The float provides buoyancy for the intercepting net 3 and the sediment barrier plate 4. By combining the counterweights 5 with the float, the intercepting net 3 and the sediment barrier plate 4 can function stably in water.

In an implementation, the hoisting device includes four winches 15, and the four winches 15 are respectively connected to four corners of the collecting tank 7 through the slings 8. Outer side surfaces of side walls of an opening of the collecting tank 7 are each provided with a vertical sliding rail 16, and inner sides of two ends of the closing plate 9 are each provided with a sliding groove 17 fitted with the vertical sliding rail 16. When the collecting tank 7 needs cleaning, the four winches 15 may operate synchronously to pull up the collecting tank 7 from beneath the water level through the slings 8. When the collecting tank 7 is pulled up to below the closing plate 9, the sliding groove 17 is aligned with the vertical sliding rail 16, and then the collecting tank 7 is further lifted until the bottom of the closing plate 9 abuts against the inner bottom surface of the collecting tank 7, such that the inlet of the collecting tank 7 is closed. Then, the collecting tank 7 may be hoisted onto a truck by a crane and transported to a designated place for disposal.

In this embodiment, there are a plurality of the counterweights 5 that are arranged at equal intervals along a length direction of the intercepting net 3, which prevents the intercepting net 3 and the sediment barrier plate 4 from being separated by the water flow, thereby ensuring the stability of the intercepting device. The counterweights 5 may be lead weights. The connecting rope between the lead weight and the intercepting net 3 has a certain flexibility, which can buffer the impact of the water flow on the intercepting net 3 and the sediment barrier plate 4 to some extent, thereby further improving the stability and reliability of the device.

Specific examples are used herein to explain the principles and implementations of the present disclosure. The foregoing description of the embodiments is merely intended to help understand the method of the present disclosure and its core ideas. Besides, various modifications may be made by those of ordinary skill in the art to specific implementations and the scope of application in accordance with the ideas of the present disclosure. In conclusion, the content of the present specification shall not be construed as limitations to the present disclosure.

What is claimed is:

1. A trash intercepting and sediment barrier device, comprising a frame, a sediment collecting device, an intercepting device and a hoisting device, wherein the intercepting device comprises a float, an intercepting net and a sediment barrier plate, the float is fixed on the frame, an upper end of the intercepting net is connected to the float, a lower end of the intercepting net is connected with a counterweight, an upper end of the sediment barrier plate is connected to the lower end of the intercepting net, the sediment barrier plate comprises a plurality of sediment barrier plate units that are sequentially hinged along a height direction, the sediment collecting device comprises a collecting tank, the collecting tank is arranged at a downstream side of the intercepting device, a side of the collecting tank facing an incoming flow is provided with an inlet, the collecting tank is connected to the hoisting device through slings, the hoisting device is fixedly mounted on the frame, an upper end of the frame is provided with a closing plate, and the closing plate is mounted at the inlet of the collecting tank and configured to close the inlet.

2. The trash intercepting and sediment barrier device according to claim 1, wherein the intercepting net comprises a plurality of intercepting net layers that are arranged sequentially, and mesh sizes of the intercepting net layers gradually decrease along a water flow direction.

3. The trash intercepting and sediment barrier device according to claim 1, wherein the upper end of the intercepting net is connected to the float through lifting rings.

4. The trash intercepting and sediment barrier device according to claim 1, wherein an inner side of the frame is fixedly provided with an integrated sensor, and the integrated sensor integrates a water quality sensor, a flow sensor and a sediment content sensor.

5. The trash intercepting and sediment barrier device according to claim 1, wherein a bottom of the collecting tank is an arc-shaped surface, and the arc-shaped surface faces the incoming flow.

6. The trash intercepting and sediment barrier device according to claim 1, wherein the float comprises floating balls and long floating cylinders that are connected alternately.

7. The trash intercepting and sediment barrier device according to claim 1, wherein the hoisting device comprises four winches, and the four winches are respectively connected to four corners of the collecting tank through the slings.

8. The trash intercepting and sediment barrier device according to claim 1, wherein there are a plurality of the counterweights that are arranged at equal intervals along a length direction of the intercepting net.

9. The trash intercepting and sediment barrier device according to claim 1, wherein outer side surfaces of side walls of an opening of the collecting tank are each provided with a vertical sliding rail, and inner sides of two ends of the closing plate are each provided with a sliding groove fitted with the vertical sliding rail.
